(19) United States
(12) Patent Application Publication
(10) Pub. No.: US 2015/0279190 A1
(43) Pub. Date: Oct. 1, 2015

(54) DEVICE AND METHOD TO ASSIST BLIND OR VISUALLY IMPAIRED ANIMALS

(71) Applicants: Gustavo Brancante, São Paulo (BR); Pedro Mancini Guedes, São Paulo (BR)

(72) Inventors: Gustavo Brancante, São Paulo (BR); Pedro Mancini Guedes, São Paulo (BR)

(21) Appl. No.: 14/227,840

(22) Filed: Mar. 27, 2014

(51) Int. Cl. G08B 21/18; G08B 7/06

(52) U.S. Cl. CPC G08B 21/182; G08B 7/06

(57) ABSTRACT

A portable electronic device, and method of using the device, for assisting blind or visually impaired animals to deviate barriers. The operation of the equipment is done by a system to capture away the obstacles ahead and the transmission of these distances for the animal as by vibrating and sound systems.

### BACKGROUND OF THE INVENTION

1. Field of the Invention

The present invention relates to an electronic device, and a method of using the electronic device, for assisting blind or visually impaired animals to deviate barriers.

2. Background Art

Currently, there are no known external electronic systems dedicated to aid the mobility of blind animals. Blind or visually impaired animals rely on other senses, especially smell, touch, and hearing to guide them. In known locations, smell is useful, but in other environments, this effect is of little help and the front shocks are constant and mobility is greatly compromised.

### SUMMARY OF THE INVENTION

In one form, the invention is directed to a device to assist blind or visually impaired animals. The device includes a portable electronic system for installation and external use. The portable electronic system consists of: a system for measuring distance by ultrasound mechanism and/or laser and cameras; an information processing system using a microcontroller and electronic components including at least one of resistors, capacitors, diodes and transistors; and a system through which distances to obstacles ahead for the animal are conveyed to the animal through at least one of a vibration unit and sound output.

In one form, the device uses a stimulus variance proportional to distances between the animal and obstacles.

In one form, vibration variance is used as a distance information mechanism.

In one form, the noise variance is used as the distance information mechanism.

In one form, the invention is directed to a portable electronic device to assist blind or visually impaired animals in avoiding an obstacle. The portable electronic device includes: an electronic processing system; and an attaching mechanism through which the electronic processing system is operatively maintained on an animal. The electronic processing system is configured to send information to the animal upon which the electronic processing system is operatively situated. The information changes as a distance between the operatively situated electronic processing system and the obstacle changes so that the animal is given an indication of a changing distance between the animal and the obstacle.

In one form, the electronic processing system has a distance measuring module which constantly measures a distance between the operatively situated electronic processing system and the obstacle and generates a distance signal.

In one form, the electronic processing system further includes a processing module that receives the signal from the distance measurement module and processes and encodes the distance signal as the information, that is distance information.

In one form, the electronic processing system further includes a transmission module that transmits the distance information to the animal upon which the electronic processing system is operatively maintained.

In one form, the distance information is transmitted as a vibration.

In one form, the distance information is transmitted as sound.

In one form, the electronic processing system is powered by at least one battery.

In one form, the portable electronic device further includes a solar energy panel through which the at least one battery can be charged.

In one form, the portable electronic device further includes an AC power supply through which the at least one battery can be charged.

In one form, the invention is directed to a method of assisting blind or visually impaired animals. The method includes the steps of: providing the portable electronic device described above; through the attaching mechanism operatively maintaining the electronic processing system on the animal; and through the electronic processing system; a) generating different distance information representative of different distances between the operatively maintained electronic processing system and the obstacle; and b) conveying the different distance information to the animal so that the different distance information can be sensed by the animal.

### BRIEF DESCRIPTION OF THE DRAWINGS

The invention will be described below with reference to exemplary embodiments thereof and also with reference to the accompanying drawings, wherein:

FIG. 1 is a schematic representation of a portable electronic device to assist blind or visually impaired animals in avoiding an obstacle, according to the invention;

FIG. 2 is a schematic representation of components used to power modules making up the device in FIG. 1; and

FIG. 3 is a flow diagram representation of a method of assisting blind or visually impaired animals, according to the invention.

### DETAILED DESCRIPTION OF THE PREFERRED EMBODIMENT

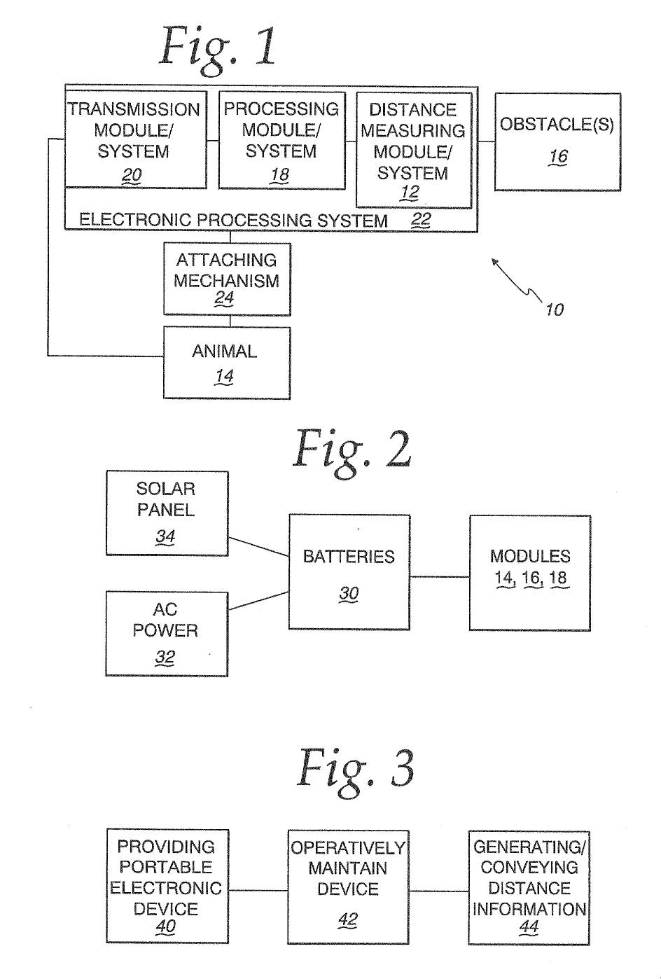

FIG. 1 illustrates a simplified portable electronic device at 10 constructed in accordance with the present invention, with schematic representation of the major modules and their functions. A distance measuring module/system 12 constantly measures the distance between the front of an animal 14 and an obstacle 16 and sends this information as a signal to a processing module/system 18, and this, in turn, processes and encodes this information, controlling in turn a transmission module/system 20 through which the distance information is transmitted to the animal 14. The modules/systems 12, 18, 20 together make up an electronic processing system 22 that can be readily devised by one skilled in the art and utilizing, for example, a microcontroller and electronic components such as resistors, capacitors, diodes and transistors, all encompassed within the schematic component depiction.

According to a method and apparatus of the present invention, it is possible to assist help locomotion of the blind and vision impaired animals 14, informing them of the distance of the obstacles 16 in their path. This information is transmitted to the animal 14 through the transmission module/system 20 by means of sound and/or vibration, with a signal proportional to the distance between the animal 14 and the obstacles ahead. The process of measuring distance is done through the distance measuring module/system 12 by broadcast techniques with ultrasound systems and/or cameras and laser beams. The device 10 is portable and can be used both on small and large animals. Its use does not require any intervention, just being dressed on the animal in an operative state through a suitable attaching mechanism 24, and can be arranged in various ways to best suit the type and size of the animal, with the restriction of distance measuring module 12, which should be positioned so as to follow the direction of movement of the animal.

FIG. 2 illustrates the acquisition and storage of electricity. The device 10, including the system 20, operates with direct current electricity, which is provided by at least one battery 30 and can be recharged by an external AC power source 32 and/or a solar energy panel 34.

As seen in FIG. 3, the invention contemplates a method of assisting blind or visually impaired animals. The method includes the step of providing a portable electronic device, as described above, as shown at block 40.

As shown at bock 42, the portable electronic device, including the electronic processing system thereof, is operatively maintained on the animal through the attaching mechanism.

As shown at block 44, through the electronic processing system, distance information is generated representative of different distances between the operatively maintained electronic processing system and the obstacle and conveyed to the animal so that the different distance information can be sensed by the animal.

Through the present invention, potentially the mobility and quality of life of animals can be maintained. The installation and use of the device is not invasive and does not offer any discomfort to the animal.

The foregoing disclosure of specific embodiments is intended to be illustrative of the broad concepts comprehended by the invention.

1. A device to assist blind or visually impaired animals comprising:
a portable electronic system for installation and external use, the portable electronic system comprising:
a system for measuring distance by ultrasound mechanism and/or laser and cameras;
an information processing system using a microcontroller and electronic components comprising at least one of resistors, capacitors, diodes and transistors; and
a system through which distances to obstacles ahead for the animal are conveyed to the animal through at least one of a vibration unit and sound output.

2. The device to assist blind or visually impaired animals according to claim 1, wherein the device uses a stimulus variance proportional to distances between the animal and obstacles.

3. The device to assist blind or visually impaired animals according to claim 2, characterized by use of variance of vibration as a distance information mechanism.

4. The device to assist blind or visually impaired animals according to claim 2, characterized by use of noise variance as a distance information mechanism.

5. A portable electronic device to assist blind or visually impaired animals in avoiding an obstacle, the portable electronic device comprising:
an electronic processing system; and
an attaching mechanism through which the electronic processing system is operatively maintained on an animal,
the electronic processing system configured to send information to an animal upon which the electronic processing system is operatively situated,
the information changing as a distance between the operatively situated electronic processing system and the obstacle changes so that the animal is given an indication of a changing distance between the animal and the obstacle.

6. The portable electronic device according to claim 5 wherein the electronic processing system comprises a distance measuring module which constantly measures a distance between the operatively situated electronic processing system and the obstacle and generates a distance signal.

7. The portable electronic device according to claim 6 wherein the electronic processing system further comprises a processing module that receives the signal from the distance measurement module and processes and encodes the distance signal as the information that is distance information.

8. The portable electronic device according to claim 7 wherein the electronic processing system further comprises a transmission module that transmits the distance information to the animal upon which the electronic processing system is operatively maintained.

9. The portable electronic device according to claim 8 wherein the distance information is transmitted as a vibration.

10. The portable electronic device according to claim 8 wherein the distance information is transmitted as sound.

11. The portable electronic device according to claim 5 wherein the electronic processing system is powered by at least one battery.

12. The portable electronic device according to claim 11 wherein the portable electronic device further comprises a solar energy panel through which the at least one battery can be charged.

13. The portable electronic device according to claim 11 wherein the portable electronic device further comprises an AC power supply through which the at least one battery can be charged.

14. A method of assisting blind or visually impaired animals, the method comprising the steps of:
providing the portable electronic device of claim 5;
through the attaching mechanism operatively maintaining the electronic processing system on the animal; and
through the electronic processing system; a) generating different distance information representative of different distances between the operatively maintained electronic processing system and the obstacle; and b) conveying the different distance information as a stimulus to the animal so that the different distance information can be sensed by the animal.
